(19) United States
(12) Patent Application Publication
(10) Pub. No.: US 2010/0270104 A1
(43) Pub. Date: Oct. 28, 2010

(54) SHAPEABLE FRAMING SYSTEM

(76) Inventor: Robert J. Atzert, Live Oak, FL (US)

Correspondence Address: KOHN & ASSOCIATES, PLLC, 30500 NORTHWESTERN HWY, SUITE 410, FARMINGTON HILLS, MI, 48334, US

(21) Appl. No.: 12/725,649

(22) Filed: Mar. 17, 2010

Related U.S. Application Data
(60) Provisional application No. 61/162,034, filed on Mar. 20, 2009.

(51) Int. Cl. E04B 1/84; H04R 1/02; F16M 13/00; E04C 2/38; B23P 17/00

(52) U.S. Cl. 181/294; 181/284; 381/386; 248/276.1; 52/656.9; 29/897.32

(57) ABSTRACT

A shapeable framing element for the construction of panels comprising mounting means to affix said shapeable framing element to a substrate, said mounting means being divided into a plurality of mounting tabs defining a plurality of channels, thereby allowing said framing element to be shaped into curvilinear forms prior to being mounted upon said substrate. A shapeable element for attaching objects to a substrate. A method for constructing a panel enclosing a desired geometric volume upon a substrate

This application claims the benefit of priority to U.S. Provisional Patent Application Ser. No. 61/162,034, which was filed on Mar. 20, 2009, and which is incorporated herein by reference.

### TECHNICAL FIELD

The present invention relates to shapeable framing elements for the construction of room sound proofing panels, especially those constructed of sound proofing material covered with fabric.

### BACKGROUND OF THE INVENTION

Acoustical sound proofing systems are used to reduce noise levels in rooms and other interior spaces where there is a need for noise reduction or improved sound quality. Examples include class rooms, media rooms, board rooms, band or chorus practice rooms, and the like. It is advantageous for such systems also to be aesthetically pleasing, as they are often exposed to the room occupants. Systems such as the Whisper Walls® System (Whisper Walls, Aurora, Colo.) provide soundproofing panels covered with a variety of fabrics. The panels are constructed of framing elements which anchor to a surface, such as a wall, in a manner which defines a framed volume, typically a rectangular solid. Insulation, typically fiberglass, fills the framed volume; and fabric is tucked into the framing elements so that it completely covers the framed volume and its filling of insulation. The framing elements can include jaws which grip the fabric covering and hold it tautly in place.

Existing framing elements for acoustical sound proofing systems are comprised of relatively rigid materials such as nylon. The rigid nature of the framing elements limits the framed volume to straight sided forms such as cubes and triangular and polygonal solids. Existing framing elements are therefore incapable of being shaped to form sound proofing panels of curvilinear forms such as circle, ovals, and serpentine solids. Without the availability of curvilinear forms, it is impossible to construct soundproofing panels in varied and artistic forms, or to construct decorative assemblies of sound proofing panels in a wide assortment of shapes.

### SUMMARY OF THE INVENTION

The present invention provides a shapeable framing element which permits the construction of fabric covered room sound proofing panels in curvilinear forms, yet which provides sufficiently strong anchorage and fabric gripping capabilities to yield sound proofing panels which are stable and durable. The shapeable framing element allows the user to design sound proofing panels, and assemblies of panels, in an unlimited variety of artistic forms, including flowers, sunbursts, and musical notes. The shapeable framing elements can also be used to construct rectilinear sound proofing panels similar to those currently known in the art. The present invention also provides methods for fabricating shapeable framing elements and for utilizing them in the construction of sound proofing systems of an unlimited variety of forms.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 shows a front elevational view of a shapeable framing element.

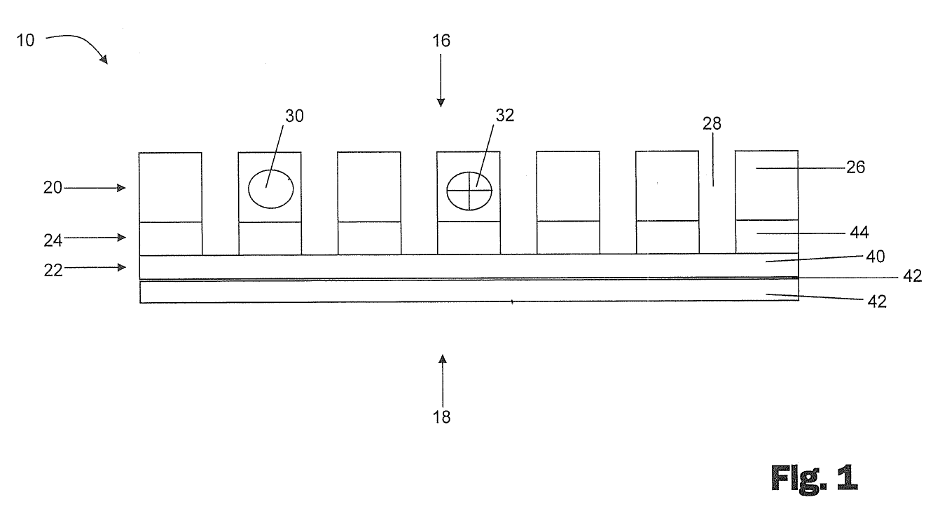

FIG. 2 shows a left elevational view of a shapeable framing element.

FIG. 3 shows a rear elevational view of a shapeable framing element.

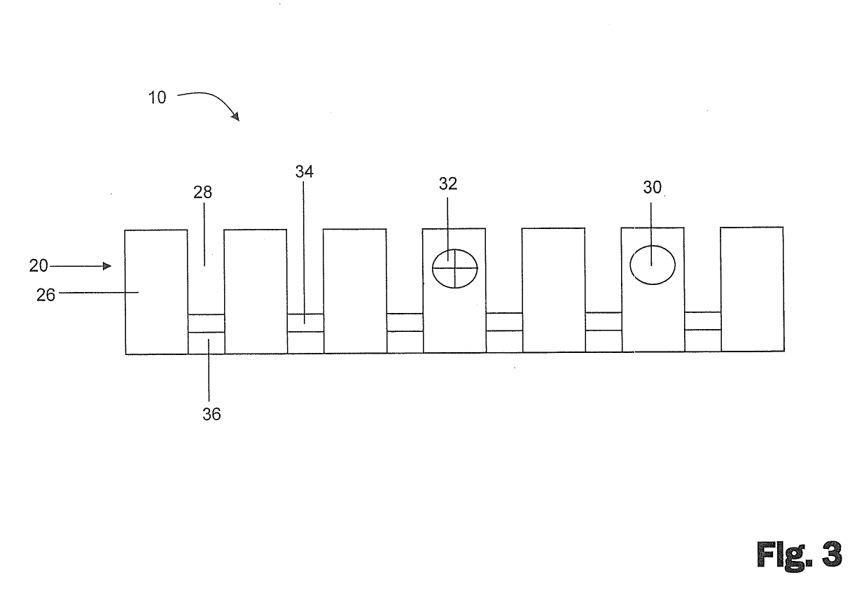

FIG. 4 shows a top side view of a shapeable framing element.

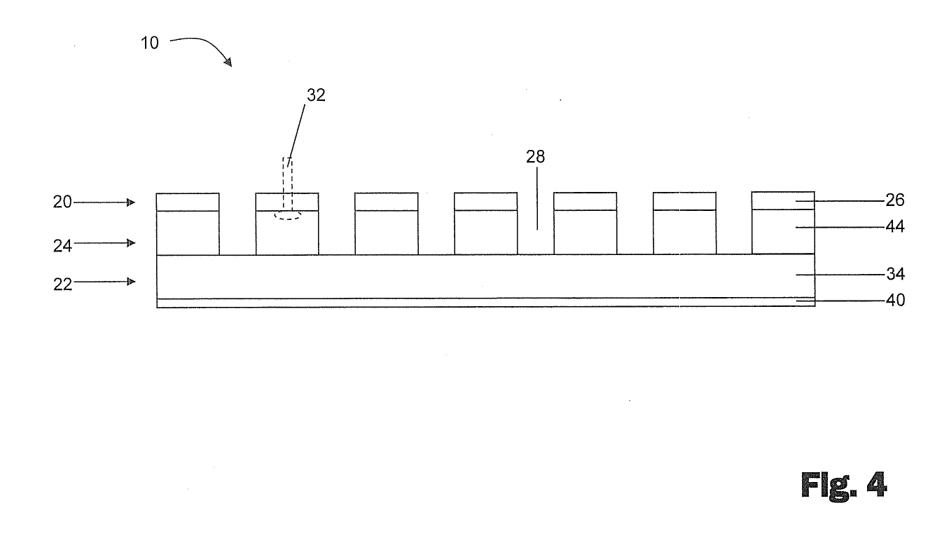

FIG. 5 shows a bottom side view of a shapeable framing element.

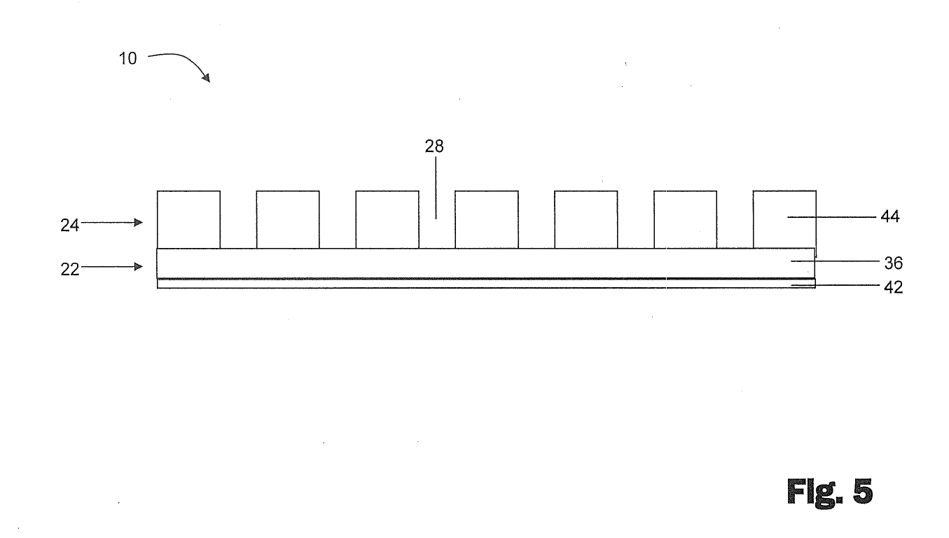

FIG. 6 shows a front elevational view of a shapeable framing element flexed into an arctuate form.

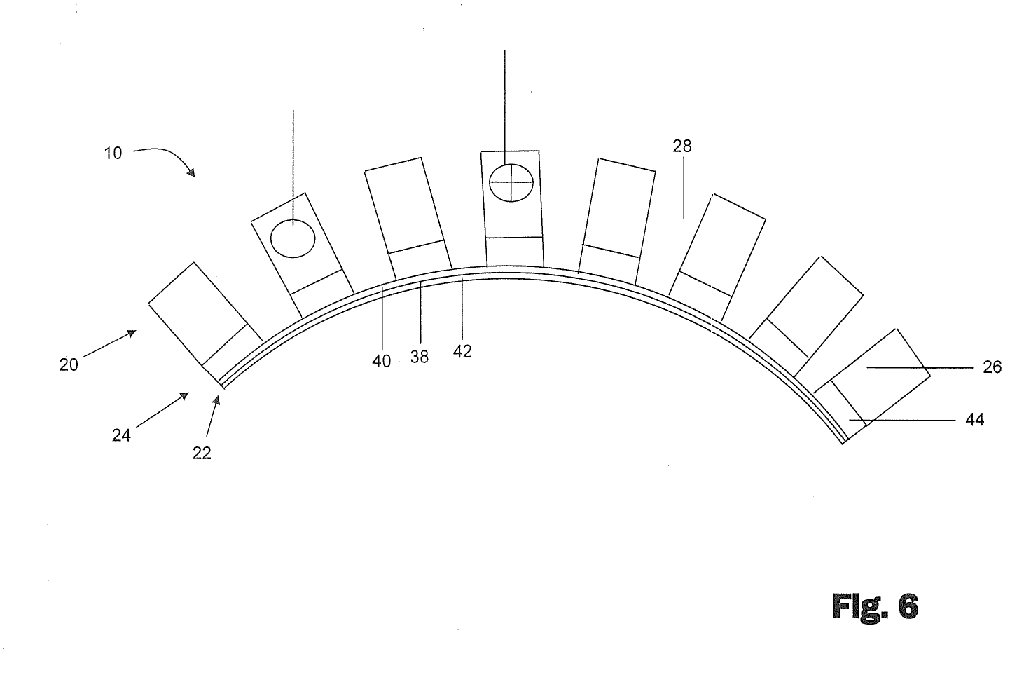

FIG. 7 shows a cross section of a sound proofing panel constructed with a single shapeable framing element.

FIG. 8 shows a plan view of two mounted shapeable framing elements.

### DETAILED DESCRIPTION OF THE INVENTION

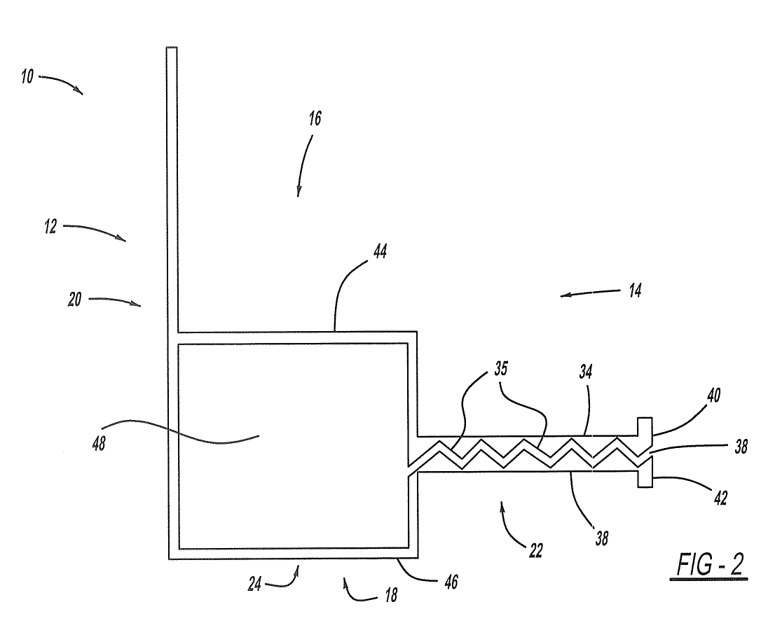

A shapeable framing element 10 according to the present invention includes a rearward side 12 which faces the wall or other substrate on which the element is mounted; a forward side 14, an upper side 16, and a lower side 18, though the terms upper and lower are not intended to be limiting. The invention comprises three portions: a rearward mounting portion 20, a forward gripping portion 22; and a connecting portion 24 located between the mounting portion 20 and gripping portion 22. The mounting portion is divided into a plurality of mounting tabs 26 which define a plurality of channels 28 therebetween. In the preferred embodiment at least one mounting tab includes at least one aperture 30 for the insertion of at least one fastener 32 as will be discussed below. The gripping portion includes an upper jaw 34 and a lower jaw 36 in close apposition to each other. In the preferred embodiment, the jaws include interlocking ridges as depicted in FIG. 2. Upper jaw 34 and lower jaw 36 define a gripping space 38 in which fabric is inserted as will be discussed below. In the preferred embodiment, upper jaw 34 includes an upper lip 40, which is an extension of the forward aspect of upper jaw 34 that curves toward the upper side 16 of shapeable framing element 10. Similarly, lower jaw 36 includes a lower lip 42, which is an extension of the forward aspect of lower jaw 36 that curves toward the lower side 18 of shapeable framing element 10. The connecting portion 24 includes an upper wall 44 which is an extension of upper jaw 34; and a lower wall 46, which is an extension of lower jaw 36. The upper wall 44 and lower wall 46 can be in close apposition for their entire lengths. In the preferred embodiment, however, the lower wall 46 includes a right angle bend toward the lower side 18 and the upper wall 44 includes a right angle bend toward the upper side 16, thereby defining, in combination with the attachment portion, a chamber 48 which is rectangular in cross section as shown in FIG. 2. Alternatively, the lower wall 46 and upper wall 44 can be bent or curved in various directions to define chambers of various shapes.

A shapeable framing element is defined as a framing element which can be flexed into curvilinear shapes prior to mounting on a substrate. The present invention, a shapeable framing element, is great improvement over the rigid framing elements known in the art. The shapeable framing element 10 can be flexed prior to mounting so that it frames an area of any desired shape, including curvilinear shapes, even complete ovals and circles. Multiple shapeable framing elements 10, shaped into diverse forms, can be used in combinations frame areas of complex shape, such as the shape of a flower or a sunburst. The shapeable framing element 10 can also, of course, be utilized in its unflexed, linear form in combinations that produce the rectilinear shapes already known in the art.

The shapeability of the present invention arises mainly from the channels 28 which divide the mounting portion 20 into individual mounting tabs 26. In the preferred embodiment, the channels 28 also extend into the connecting portion 24, leaving only the gripping portion 24 undivided. The division of the mounting portion 20 and optionally of the connecting portion 24 allow the shapeable framing element 10 to flex, much as the division of the human spine into vertebrae allows the human back to flex. In framing elements known in the art, the mounting portion and connecting portions comprise a single, continuous, relatively rigid unit.

In the preferred embodiment, shapeable framing element 10 is preferably made of nylon but can alternatively be made of any material known in the art that provides sufficient strength, durability, and elasticity, including such plastics as fiberglass, polyethylene, and polyfluorocarbons; of rubber; of metals such as steel alloys; and of wood. The shapeable framing element 10 can be fabricated in any length and cut to lengths suitable for storage, shipping, or for a specific framing job. A preferred method of fabrication is to provide a rigid Whisper Wall® framing element and cut channels into its mounting and connecting portions with a buzz saw. In the preferred embodiment, channels 28 are cut with a width of ⅛ inch and the mounting tabs 26 have a width of ½ inch. The mounting tabs 26 and channels 28 all have a length of 1 inch. However, it is understood by those skilled in the art that any channel and mounting tab dimensions may be used without departing from the principles of the invention, as long as the resulting product provides a shapeable framing element with desirable shapeability and strength. In the preferred embodiment, the forward edge of the gripping portion 22 projects forward ½ inch relative to the rearward side of shapeable framing element 10. The distance that the gripping portion 22 projects forward, however, will be vary according to the desired depth of the framed volume, as will be seen below.

Alternatively, shapeable framing element 10 can be molded as a single unit, with mounting tabs 26 and channels 28 formed in the molding process. Shapeable framing element 10 can also be assembled from individual components. For example, separate mounting, connecting, and gripping components can be assembled to serve the functions of mounting portion 20, connecting portion 24, and gripping portion 22, respectively. With this option, the shapeable framing element 10 can be constructed of components of diverse materials, with each component optimized for its specific function.

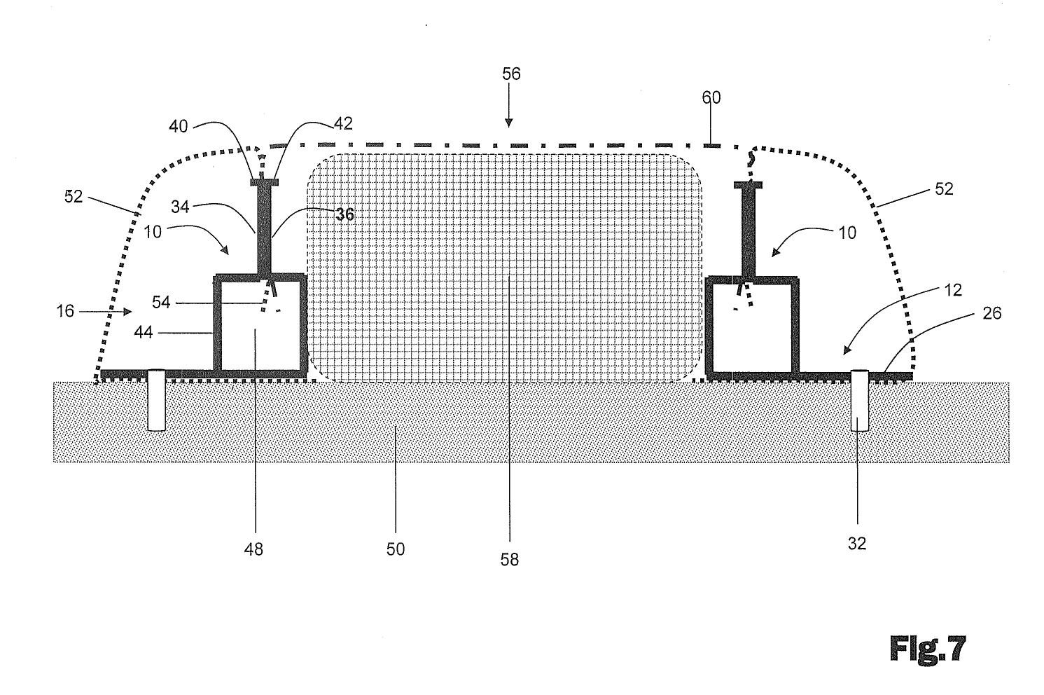

A method for constructing a soundproofing panel of any desired shape is shown in FIG. 7. FIG. 7 is a cross sectional view of a single shapeable framing element flexed into an arc, which is why two sections of the shapeable framing element appear. The outline of the shape of the panel (not shown) is inscribed on a wall 50 or other substrate. A fabric strip 52 of the desired material and design, preferably 2 inches in width, is attached to the wall 50 or other substrate, using any suitable adhesive known in the art, following the inscribed outline. Shapeable framing element 10 is then flexed to follow the outline of the fabric strip 52 and placed with the rearward side 12 in contact with fabric strip 52. Shapeable framing element 10 is then mounted securely onto fabric strip 52 and underlying wall 50. Preferably mounting is accomplished by inserting at least one fastener 32, such as a screw, through at least one mounting tab 26 and driving the screw through fabric strip 52 and into underlying wall 50. Alternatively, mounting can be accomplished with nails, bolts, rivets, or any other fastener known in the art; or it can be accomplished by stapling at least one mounting tab 26 fabric strip 52 and the underlying substrate; or it can be accomplished by cementing at least one mounting tab 26 to fabric strip 52.

After shapeable framing element 10 is securely mounted, the exterior edge 54 of fabric strip 52 is tucked between the upper jaw 34 and lower jaw 36 of gripping portion 22 so that fabric strip 52 is stretched taut. The exterior edge 54 of fabric strip 52 is defined as the edge which projects over the upper side 16 of shapeable framing element 10. The mounting process continues until a desired framed volume 56 is defined by one or more shapeable framing elements 10.

Next, framed volume 56 is filled with soundproofing material 58. Preferably, the soundproofing material is made of fiberglass, but it can alternatively be made of any soundproofing material known in the art, such as rock wool, celled foams, and baffles of rubber, plastic, or cardboard. The maximum depth of the soundproofing material 58 typically matches the distance to which the gripping portion 22 projects beyond the rearward side 12 of shapeable framing element 10. With this configuration, the soundproofing material 58 is flush with the fabric covering 60 to be discussed below. This produces panel with smooth, flat appearance. Alternatively, the sound proofing material 58 can project beyond the gripping portion 22. This will produce a “puffy” effect when fabric covering 60 is installed, adding to the artistic possibilities provided by the invention. Note that fillings other than sound proofing materials may be utilized, for example thermal insulation. Panels constructed with shapeable framing elements may alternatively be used to enclose loudspeakers. The framed volume 56 may alternatively be left unfilled, if a purely decorative panel is desired.

Finally, fabric covering 60, preferably of the same pattern and material as fabric strip 52, is tucked between the upper jaw 34 and lower jaw 36 of gripping portion 22 so that fabric it is stretched taut. The free ends of fabric strip 52 and fabric covering 60 may protrude into chamber 48 as depicted in FIG. 7, or they may reside entirely within upper jaw 34 and lower jaw 36 of gripping portion 22. The result is a soundproofing panel in which appears to the viewer to be a seamless panel of fabric, as the shapeable framing elements are completely hidden underneath fabric strip 52 and fabric piece 60.

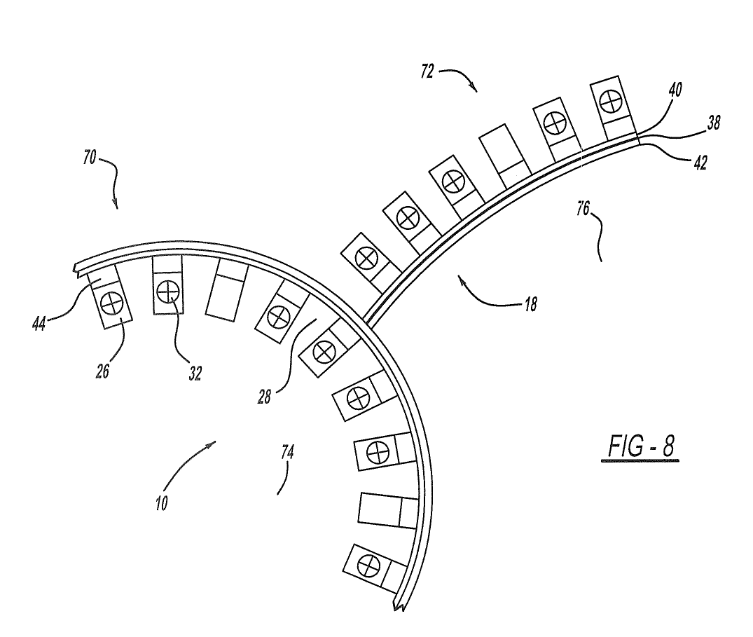

Conjoined assemblies of sound proofing panels can also be constructed through the use of the present invention. In this manner, complex artistic works can be produced. The method is as described above for individual panels, but the at least two shapeable framing elements are mounted in a side to side joining as in FIG. 8 or in a butt end or other joined configuration (not shown). In FIG. 8, a first shapeable framing element 70 is joined to a second shapeable framing element 72 in a side to side join, where the first shapeable framing element 70 defines a portion of a framed volume representing the central body of a flower 74 and the second shapeable framing element 72 defines a portion of a framed volume representing a petal of the same flower 76.

Obviously, many modifications and variations of the present invention are possible in light of the above teachings. It is, therefore, to be understood that within the scope of the appended claims wherein reference numerals are merely for convenience and are not to be in any way limiting, the invention may be practiced otherwise than as specifically described.

The invention claimed is:

1. A shapeable framing element for the construction of panels comprising mounting means to affix said shapeable framing element to a substrate, said mounting means being divided into a plurality of mounting tabs defining a plurality of channels, thereby allowing said framing element to be shaped into curvilinear forms prior to being mounted upon said substrate.

2. The shapeable framing element of claim 1 wherein said substrate is selected from the group consisting of a wall and a ceiling.

3. The shapeable framing element of claim 1 further comprising gripping means to grip a fabric covering.

4. The shapeable framing element of claim 3 wherein said gripping means comprises an upper jaw and a lower jaw.

5. The shapeable framing element of claim 3 further including connecting means to connect said gripping means to said mounting means.

6. The shapeable framing element of claim 5 wherein said connecting means is divided into a plurality of segments defining a plurality of channels, the channels being continuous with said plurality of channels defined by said plurality of mounting tabs.

7. The shapeable framing element of claim 5 wherein said mounting means, said gripping means, and said connecting means each comprise a flexible material.

8. The shapeable framing element of claim 7 wherein said flexible material is selected from the group consisting of nylon, fiberglass, polyethylene, a polyfluorocarbon, steel, a metal, and wood.

9. The shapeable framing element of claim 1 wherein at least one mounting tab of said plurality of mounting tabs includes at least one aperture, said at least one aperture being suitable to accommodate at least one fastener.

10. A panel for mounting on a substrate, comprising at least one shapeable framing element, said shapeable framing element comprising mounting means to affix said shapeable framing element to said substrate, said mounting means being divided into a plurality of mounting tabs defining a plurality of channels, gripping means for gripping a fabric covering, and connecting means connecting said mounting means to said gripping means, wherein said at least one shapeable framing element encloses a portion of said substrate that is selected from the group consisting of a rectilinear shape and a curvilinear shape.

11. The panel of claim 10 wherein said at least one shapeable framing element is further defined as a plurality of framing elements mounted contiguously upon said substrate.

12. The panel of claim 10 wherein said substrate is selected from the group consisting of a wall and a ceiling.

13. The panel of claim 10 wherein said enclosed portion of said substrate is further defined as a geometric volume whose sides consist of said substrate, said connecting means, and a fabric covering held above said substrate by said gripping means at a height corresponding to the height of said gripping means.

14. The panel of claim 13 wherein said geometric volume contains a soundproofing material.

15. The panel of claim 14 wherein said soundproofing material is selected from the group consisting of fiberglass, rock wool, celled foams, a rubber baffle, a plastic baffle, and a cardboard baffle.

16. The panel of claim 13 wherein said geometric volume contains at least one loudspeaker.

17. A shapeable element for attaching objects to a substrate comprising mounting means to affix said shapeable element to a substrate, said mounting means being divided into a plurality of mounting tabs defining a plurality of channels, thereby allowing said mounting element to be shaped into curvilinear forms prior to being mounted upon said substrate.

18. A method for constructing a panel enclosing a desired geometric volume upon a substrate including the steps of:
defining upon the substrate an outline of a desired geometric volume;
mounting upon the substrate a fabric strip that conforms to the outline of the desired geometric volume such that a lateral edge of the fabric strip that faces an interior of the desired geometric volume defines a fixed edge, being affixed to the substrate, and an opposite lateral edge of the fabric strip is a free edge, being unaffixed to the substrate;
providing at least one shapeable framing element, comprising mounting means to affix the at least one shapeable framing element to the substrate, the mounting means being divided into a plurality of mounting tabs defining a plurality of channels, gripping means suitable for gripping a fabric covering, and connecting means connecting the mounting means to the gripping means,
flexing the at least one shapeable framing element to conform to the outline of the fabric strip;
placing the at least one shapeable framing element upon the fixed edge of the fabric strip, such that the plurality of mounting tabs faces the interior of the desired geometric volume;
providing at least one fastener;
fastening to the substrate at least one of the plurality of mounting tabs, further including the step of driving the at least one fastener through the at least one mounting tab, through the fixed edge of the fabric strip, and into the substrate;
tucking the free edge of the fabric strip into the gripping means of the at least one shapeable framing element;
providing a fabric covering pre-cut to conform to the outline of the desired geometric volume; and
tucking the edges of the fabric covering into the gripping means such that the fabric covering extends over the area enclosed by the outline of the geometric volume.
